(19) United States
(12) Patent Application Publication
(10) Pub. No.: US 2008/0107480 A1
(43) Pub. Date: May 8, 2008

(54) Joining system, individual elements and method for use thereof

(76) Inventor: Svein Berg, Isfjorden (NO)

Correspondence Address: CHRISTIAN D. ABEL, ONSAGERS AS, POSTBOKS 6963 ST. OLAVS PLASS, NORWAY, N-0130, NO

(21) Appl. No.: 11/927,761

(22) Filed: Oct. 30, 2007

Related U.S. Application Data
(63) Continuation-in-part of application No. 11/570,969.

(30) Foreign Application Priority Data
Jun. 30, 2004 (NO) 20042767

(51) Int. Cl. F16B 17/00

(52) U.S. Cl. 403/293

(57) ABSTRACT

The present invention regards a bridge element for use in a joining system for connecting two elements, for example a pillar (11) and a concrete beam (10), comprising a receiving device (1) mounted in one of the elements (10;11), a box element (3) mounted in the second element (11;10), where the bridge element is located partly in the receiving device (1) and partly in the box element (3) in a connected condition of the joining system. The bridge element (2) has a width, height and length, where a corner edge, which in a connected position of the joining system is facing out of the box element (3), is bevelled, thereby forming an obliquely orientated surface (21), which can be employed for returning the bridge element (2) into the box element (3).

### CROSS-REFERENCE TO RELATED APPLICATIONS

This application is a Continuation-in-part application of pending U.S. application Ser. No. 11/570,969 filed Dec. 20, 2006, which was the US National Stage application of PCT/NO2005/000220 filed Jun. 22, 2005.

### FIELD OF THE INVENTION

The present invention relates to a bridge element for use in a system for joining two elements, for example two building elements such as a concrete pillar and a concrete beam, comprising a box element disposed in one element, a receiving device in the second element and where the bridge element in a connected state of the system is positioned partly within the box element and partly within the receiving device, for transferring forces between the elements.

### BACKGROUND

Solutions are known in the prior art for connecting elements in this way, for example concrete beams and pillars. In NO 166963 a system is described for joining pillars and beams made of concrete. Supporting boxes are embedded in pillar and beam with open sides directed out of the pillar/beam, with the result that their open sides will be flush with each other during installation and flush with an outer surface of the beam or pillar. A bridge element is mounted in the beam and moved by means of a wedge element into the supporting box in the pillar so that the bridge element is arranged in both the supporting boxes in order to obtain a good load transfer between the elements. The wedge element is inserted from the top surface of the beam.

The known systems have the problem that they consist of a number of separate part. These parts have to be located correctly in relation to one another in order to achieve a good power transfer and a reliable and stable connection between the elements that have to be joined.

Another problem with known solutions is how the bridge element may be returned to an initial position if the system has to be released again before it is fully set.

### SUMMARY OF THE INVENTION

It is an object of the present invention to provide a connecting system between two elements that is easy to use, consists of only a few parts) provides a reliable connection that is easy to install and requires the use of little extra equipment, and where the above-mentioned drawbacks are avoided or reduced to a minimum.

This object is achieved with a bridge element for use in a joining system as indicated in the following claims.

The invention relates to a bridge element for use in a joining system for connecting two concrete elements, for example a pillar and a beam, or alternatively a staircase element and stair well or the like. The joining system comprises a receiving device mounted in one of the concrete elements, a box element mounted in the other concrete element and the bridge element is located partly in the receiving device and partly in the box element in a connected condition of the joining system. The bridge element transfers the forces from the box element to the receiving device and in the most common case from a concrete beam containing the box element to a pillar with a receiving device. In a joining phase the bridge element is mounted movably in the box element from a withdrawn position where it is mainly located within the box element to a connected position where it is partly in the box element and partly in the receiving device.

According to the invention the bridge element, which is like a key in the joining system, has a width, height and length, where a corner edge, which in a connected position of the joining system is facing out of the box element, is bevelled so as to form an obliquely orientated surface that can be used to return the bridge element into the box element. This is done, for example, by inserting an element in the gap between the concrete elements. This element will interact with the obliquely oriented surface and thereby due to the oblique orientation of part of the bridge element, press the bridge element back into the box element and the two elements that should be joined are released again.

In addition in a preferred embodiment the bridge element also has a corner edge, which in a connected position of the joining system is facing into the box element and towards the pipe element, which edge is also bevelled so as to form a second obliquely orientated surface that can be used to move the bridge element out of the box element into engagement with the receiving device.

According to the invention the invention the corner edge facing out of the system has the obliquely oriented surface facing upwards in a connected state of the system, and an upper edge of this obliquely oriented surface has in one embodiment a position mainly in line with an outer surface of the element comprising the receiving device in a connected state of the joining system. It is also possible to envisage that this upper edge is arranged so that it is positioned outside the element comprising the receiving device or within this element. The angle on this obliquely oriented surface will depend on the dimensions of the elements to be connected and the positioning of the joining system in relation to these elements.

These features of the present invention provide a joining system that is easy to produce, install in the concrete element and is reliable and easy to use for joining two concrete elements.

### BRIEF DESCRIPTION OF THE DRAWINGS

The invention will now be explained in greater detail by an embodiment with reference to the attached figures, in which:

FIG. 1 is a perspective view of a joining device according to the invention,

FIG. 2 is a perspective view of a bridge element for use in the joining device,

FIG. 3 is a perspective view of an embodiment of a reinforcing rod,

FIG. 4 is a perspective view of the box element for use in the joining device,

FIG. 5 is a view of a joining device according to the invention employed for joining a concrete beam and a pillar,

FIG. 6 is a view of another embodiment of a joining device, and

FIG. 7A and FIG. 7B are side views of two embodiments of a bridge element according to the invention

### DETAILED DESCRIPTION

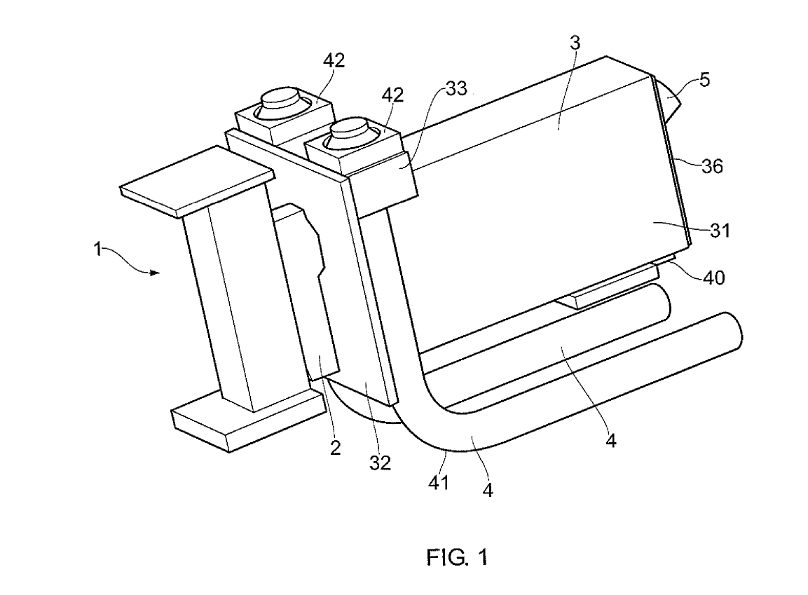

FIG. 1 illustrates a joining device according to the invention comprising a receiving device 1, a bridge element 2 and a box element 3. The joining device is illustrated in a connected condition where the bridge element 2 is shown placed partly inside the receiving device 1 and partly inside the box element 3. The box element 3 is provided with two reinforcing rods 4 and a pipe element 5 is mounted in a wall of the box element 3.

The individual elements constituting the joining device may be designed differently, where the receiving device 1 may merely be a cut-out in a concrete element or a box profile or the like.

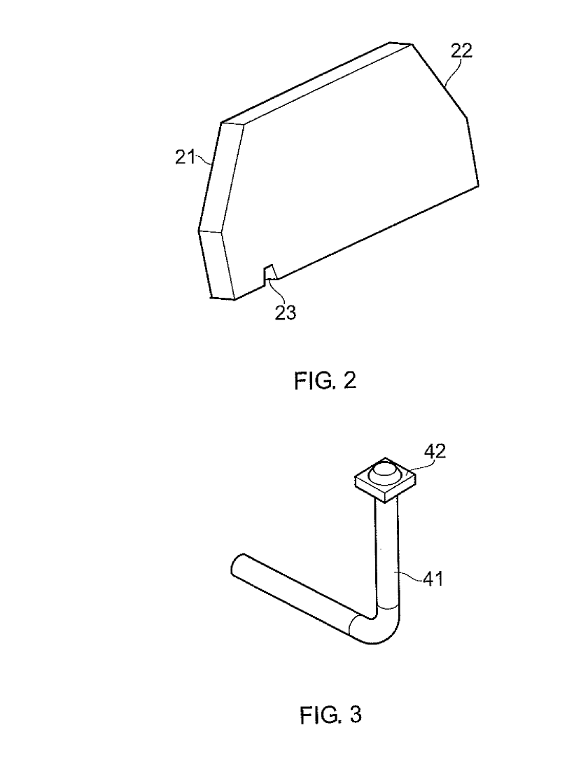

In FIG. 2 a perspective view of a bridge element according to the invention is illustrated. The bridge element 2 has a width, a height and a length, where the width is substantially smaller than the height and the length is in a direction from the box element to the receiving element. Furthermore, the bridge element 2 comprises a first obliquely orientated surface 21 along the edge facing upwards towards the receiving element, the purpose of this first obliquely orientated surface being to assist if the bridge element has to be returned into the box element in the event that the joining process has not achieved the desired result. At the opposite end of the bridge element 2 there is also an upwardly facing second obliquely orientated surface. This second obliquely orientated surface 22 is employed for moving the bridge element into engagement with the receiving element. The bridge element, moreover, also comprises a locking dog 23 at a lower edge at the same end as the first obliquely orientated surface 21.

FIG. 3 illustrates an embodiment of a reinforcing rod 4. At one end of the reinforcing rod 4 is a thickening portion, in this case a plate element 42 that is welded or screwed to the reinforcing rod 4. The reinforcing rod further comprises an angled portion 41 that is designed so that two sections of the reinforcing rod form an angle of approximately 90 degrees to each other. The thickening portion of the reinforcing rod can be obtained in a number of ways; a threaded nut, an upsetting of the rod, a bore with through-going stop element, etc.

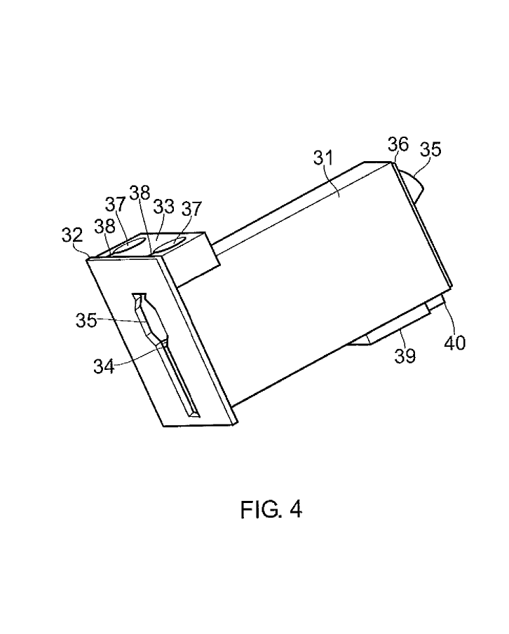

FIG. 4 is a perspective view of an embodiment of a box element according to the invention. The box element comprises a beam box 31, a front plate 32 and a back plate 36. In the upper edge of the beam box 31 and flush with the front plate is mounted an attachment element 33 for attaching reinforcing rods. The attachment element 33 has two through-going holes 37 that have a centre axis parallel to the front plate 32 and a side plate of the beam box 31. The front plate 32 is extended upwards so that the upper edge of the front plate 32 is flush with the upper edge of the attachment element 33. In this embodiment the holes 37 are provided without internal threads since they are intended to cooperate with the reinforcing rods illustrated in FIG. 3 which only have a plate element mounted at one end. The position of the holes 37 is also such that they extend on the side of the beam box 31. The holes 37 are also provided with a small cut slot 38 facing the front plate 32, thus substantially simplifying production. The front plate 32 has a slot opening 34 of a shape substantially corresponding to the bridge element's cross section, thus also providing a guide function for the bridge element 2. In the illustrated embodiment the slot opening 34 in one portion has been provided with an additional cut-out 35 or an extension. Here this cut-out is made in connection with the slot opening 34, but may well be separate from the slot opening as one or more through-going holes. This additional cut-out also provides access to the interior of the box element in a connected condition of the joining device where the bridge element is located partly inside the box element. This offers the capability of supplying the box element with filler, thereby securing the bridge element in the box element.

The box element further comprises a pipe element 5 which in the illustrated embodiment is provided protruding through the back plate 36 of the box element 3.

In an embodiment the pipe element 5 can also be placed through a side wall or top or bottom plate of the box element according to what is appropriate for the concrete elements concerned that have to be joined. The pipe element 5 has a centre axis extending at an angle relative to a guide direction for the bridge element 2, thus providing access from the top of the concrete beam. The pipe element can then also be used for inserting an element such as a crowbar for moving the bridge element from a retracted position in the box element to an engaged position with the receiving device, by the crowbar sliding towards the second slanting surface on the bridge element 2 (see FIG. 2). The box element 3 may also include reinforcing elements 39 and additional attachment elements 40 for reinforcing rods 4.

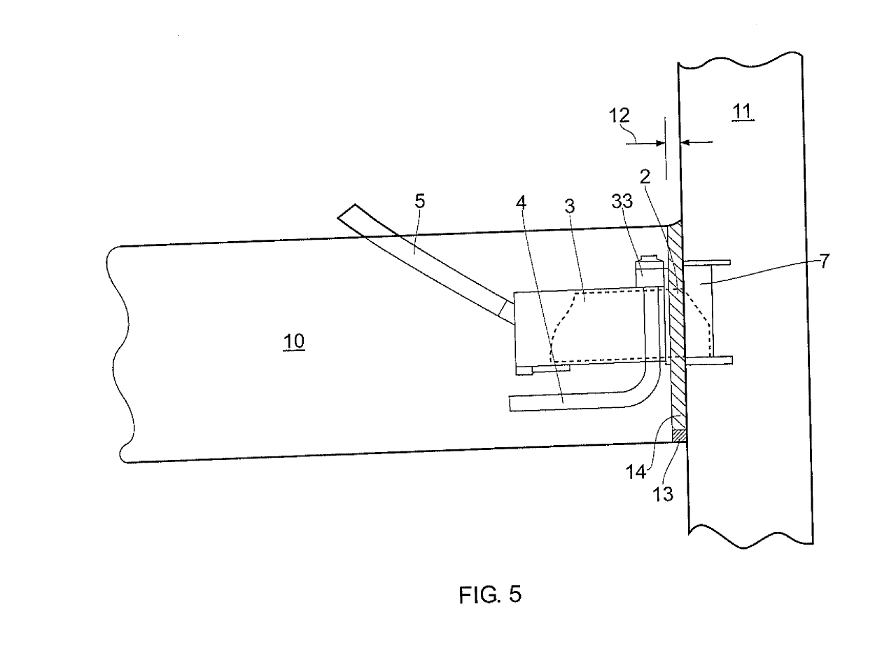

FIG. 5 illustrates an embodiment of the joining device according to the invention arranged for joining a beam 10 and a pillar 11. The box element 3 is mounted in the beam 10 with the front plate flush with the end edge of the beam, and a receiving device 1 is mounted in the pillar 11. The box element 3 is secured to the beam in the casting process by angled reinforcing rods 4 amongst other things inserted in an attachment element 33 fixed to the box element 3. In the rear edge of the box element 3 is a pipe element 5 which is extended up to a top of the beam 10. Between the beam 10 and the pillar 11 is a gap 12 in a connected position of the joining device. When the joining device is permanently mounted, this gap and the interior of the box element and the receiving device can be supplied with filler by placing a gasket 13 in the lower edge of the gap and supplying filler 14 in the upper edge of the gap and in the pipe element 5. The filler will penetrate into the box element 3 through the pipe element 5 and also the cut-out opening in the front plate of the box element, thereby providing a secure connection between the beam 10 and the pillar 11.

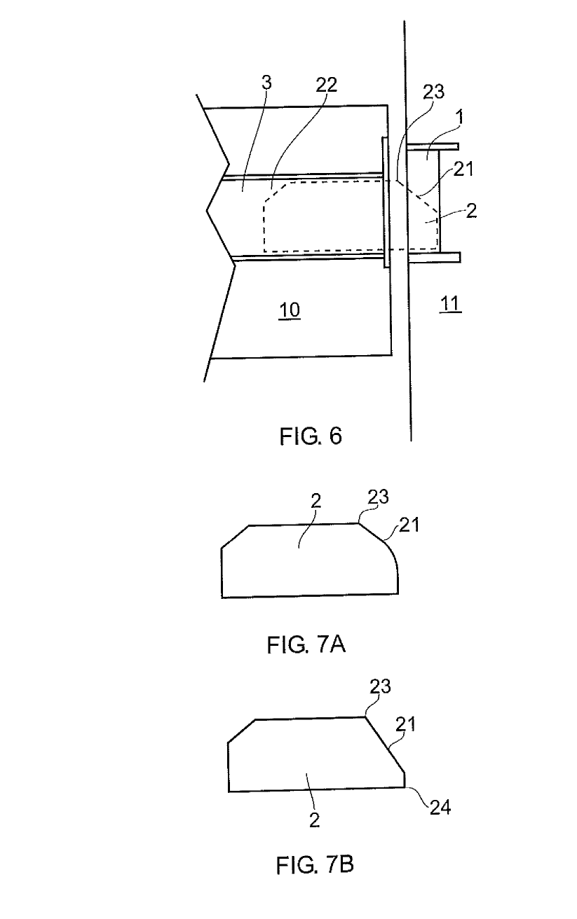

In FIG. 6 one can see mainly the same element as in FIG. 5 somewhat simplified. In this embodiment the oblique surface 21 of the bridge element 2 is facing upwards and has an upper edge 23 which in this embodiment is positioned outside the receiving device 1 in the one element 11, in a connected state of the joining device. This is in contradiction to the embodiment in FIG. 5 where the similar upper edge is positioned in line with an outer surface of the receiving device in the one element.

In FIGS. 7A and 7B there are shown two further embodiment of possible bridge elements, in FIG. 7A the oblique surface 21 is formed with a radius and thereby formed as a rounded surface from the upper edge 23 of the bridge element. The radius may be constant or vary along the oblique surface. In 7B the oblique surface 21 is linear and extends from the upper edge 23 and almost to a lower corner 24 of the part of the bridge element facing the receiving device 1.

The invention has now been explained with reference to a detailed embodiment. A number of variants and variations may be envisaged in relation to the explained embodiment that are within the scope of the invention as defined in the attached patent claims. For example, the box element may have internal control elements for the bridge element, the bridge element may be equipped with guide rope instead of obliquely orientated surfaces, the pipe element may extend from a top or lateral surface of the box element and at an angle to the guide device for the bridge element, there may be several through-going holes in the front plate, the outside of the box element may contain ribs for a better attachment to the concrete, the attachment element may comprise two or more separate parts mounted at different points on the box element, the reinforcing rods may be upset at the end instead of containing a welded-on plate element, or they may be secured by bolts. It is conceivable that the elements that have to be joined may be elements other than concrete elements, for example made of composite material or that the two elements are made of different materials such as the beam made of concrete and the pillar of a different material.

1. A bridge element for use in a joining system for connecting two elements, for example a pillar (11) and a concrete beam (10), comprising a receiving device (1) mounted in one of the elements (10;11), a box element (3) mounted in the second element (11;10), where the bridge element is located partly in the receiving device (1) and partly in the box element (3) in a connected condition of the joining system, characterised in that the bridge element (2) has a width, height and length, where a corner edge, which in a connected position of the joining system is facing out of the box element (3), is bevelled, thereby forming an obliquely orientated surface (21), which can be employed for returning the bridge element (2) into the box element (3).

2. A bridge element according to claim 1, characterised in that the bridge element (2) has a width, height and length, where a corner edge, which in a connected position of the joining system is facing into the box element (3) and towards the pipe element (5), is bevelled, thereby forming an obliquely orientated surface, which can be employed for moving the bridge element (2) out of the box element (3) and into engagement with the receiving device (1).

3. A bridge element according to claim 1, characterised in that an upper edge of the obliquely surface (21) is positioned outside the receiving device (1) in a connected position of the joining system.

4. A bridge element according to claim 1, characterised in that an upper edge of the obliquely surface (21) is positioned in line with an outer surface of the elements (11) comprising the receiving device (1), in a connected position of the joining system.

5. A bridge element according to claim 1, characterised in that the oblique surface (21) is formed with a radius.

6. A bridge element according to claim 1, characterised in that the oblique surface (21) is linear.
